(19) United States
(12) Patent Application Publication
(10) Pub. No.: US 2026/0342788 A1
(43) Pub. Date: Oct. 29, 2026

(54) SECURITY ENHANCEMENT OF ONLINE CONFERENCE BY CONTINUOUS PARTICIPANT AUTHENTICATION

(71) Applicant: Kyndryl, Inc., New York, NY (US)

(72) Inventors: Bijo Sebastian Kappen, Bangalore (IN); Tudor Catalin Bazavan, Bucharest (RO); Dan Adrian Doroiman, Otopeni (RO); Tomasz Królikowski, Bytom (PO)

(21) Appl. No.: 19/188,073

(22) Filed: Apr. 24, 2025

(51) Int. Cl. H04L 9/40; H04L 12/18

(52) U.S. Cl. CPC H04L 63/0861; H04L 12/1813

(57) ABSTRACT

Embodiments relate to enhancing security of online conferences by continuous participant authentication. Aspects include, in response to a participant connecting to a conference, inputting variables into a context analysis model in order to generate a sensitivity score, where the variables relate to the conference. Aspects include determining recognition level thresholds associated with the conference based on the sensitivity score and determining, by a recognition model, a recognition score of the participant based on user data associated with the participant. Aspects include determining an authentication event in accordance with a relationship between the recognition score and the recognition level thresholds and causing the participant to perform a reauthentication in response to the authentication event. A successful reauthentication maintains a connection to the conference, and an unsuccessful reauthentication disconnects the participant from the conference.

### BACKGROUND

The present invention generally relates to computer systems, and more specifically, to computer-implemented methods, computer systems, and computer program products configured and arranged for enhancing security of online conferences by continuous participant authentication.

A web conference or virtual conference may be utilized to refer to various types of online conferencing and collaborative services including webinars (web seminars), webcasts, and web meetings. In general, online conferencing is made possible by Internet technologies and can allow real-time point-to-point communications as well as multicast communications from one sender to many receivers. For example, an online conference is an event that takes place over the Internet, which allows people to meet, share knowledge, and collaborate from around the world without being physically present by using computer systems as communication devices. Online conferences, as real-time online meetings, can use various conferencing software solutions and services.

### SUMMARY

Embodiments of the present invention are directed to computer-implemented methods for enhancing security of online conferences by continuous participant authentication. A non-limiting computer-implemented method includes, in response to a participant connecting to a conference, inputting variables into a context analysis model in order to generate a sensitivity score, where the variables relate to the conference. The method includes determining recognition level thresholds associated with the conference based on the sensitivity score and determining, by a recognition model, a recognition score of the participant based on user data associated with the participant. The method includes determining an authentication event in accordance with a relationship between the recognition score and the recognition level thresholds and causing the participant to perform a reauthentication in response to the authentication event. A successful reauthentication maintains a connection to the conference, and an unsuccessful reauthentication disconnects the participant from the conference.

Other embodiments of the present invention implement features of the above-described methods in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computer system for use in conjunction with one or more embodiments;

FIG. 2 depicts a block diagram of an example system for automatically enhancing security of online conferences by continuous participant authentication and for automatically performing security actions to protect the security of the online conference according to one or more embodiments;

FIG. 3 is a flowchart of a computer-implemented method for automatically enhancing security of online conferences by continuous participant authentication and for automatically performing security actions to protect the security of the online conference according to one or more embodiments;

FIG. 4A depicts a block diagram of example recognition thresholds according to one or more embodiments;

FIG. 4B depicts a block diagram of an example deepfake threshold according to one or more embodiments;

FIG. 5 depicts an example graph explaining details of the decision system according to one or more embodiments;

FIG. 6 depicts a flowchart illustrating details of context analysis according to one or more embodiments;

FIG. 7 depicts a block diagram of details for continuous learning for the machine learning models according to one or more embodiments

FIG. 8 is a flowchart of a computer-implemented method for automatically enhancing security of online conferences by continuous participant authentication and performing security actions according to one or more embodiments;

FIG. 9 depicts a cloud computing environment according to one or more embodiments; and

FIG. 10 depicts abstraction model layers according to one or more embodiments.

### DETAILED DESCRIPTION

One or more embodiments automatically enhance security of online conferences by continuous participant authentication and automatically performing security actions to protect the online conference. The present disclosure provides a system for increasing the security of digital online conferences (e.g., audio and video) through protection from impersonation both by a person and/or by a deepfake model. According to one or more embodiments, the system provides a just-in-time assessment, a recognition of the criticality of the meeting content, and a dynamic determination of the confidence level in the authenticity of the participant. One or more embodiments apply organizational policies on required participant authenticity levels vis-a-vis content criticality levels. To secure the online conference, the present disclosure dynamically (in real-time or near real-time) asks for explicit or implicit authentication of the participant and performs reauthentication or periodic authentication of the participant based on organization policies, confidence levels of the participant, and content criticality. Further, the system improves authentication confidence levels through continuous learning and optimization from authentication events. Moreover, one or more embodiments execute security actions to protect the online conference in the event of a failure to receive implicit or explicit authentication from the participant of the online conference, thereby preventing cybersecurity issues in the online conference.

Further, the online conference may include an interactive communication environment utilizing, for example, an interactive communication system in which users can communicate in real-time with each other. Interactive communication environments can include various types of computing environments, which may be computer generated environments that require computer systems/equipment to access and interact. For example, one could not access and operate in an interactive communication environment with a simple pen/pencil and sheet of paper, as understood by one of ordinary skill in the art. Interactive communication environments can include virtual reality, extended reality, augmented reality, gaming environments of a gaming systems, chat environments, etc. Interactive communication environments allow a communication, such as an audio communication (e.g., voice, video, music, etc.) and/or text communication, from a first participant to be automatically output in real time, for example, on a display and/or on speakers to a second participant without requiring the second user to take an action to receive the output. For example, emails between users may not be considered an interactive communication environment because, even after an email has been sent to the recipient, the recipient has to take an additional action/step to access/view the email such as opening the email, hovering over the email, selecting the email, etc.

With modern advances in artificial intelligence (AI), it is easier to spoof voice or video of users in convincing manner. It is often found that participant may step away and take short breaks especially from long online meetings while the meeting continues to stream from their communication device, for example, laptops, computers, phones, tablets, etc. Presenters or other remote participants may not be aware of this absence. This presents several risks depending on the criticality of the meetings. There is a risk that “joining details,” such as the meeting identification (ID), password/pin, meeting link (e.g., uniform resource locator (URL) or address), etc., of meetings may reach unwanted personnel, especially in the case of recurring online meetings. This may allow a cyberattacker to directly join a private conference impersonating one or more users or allow an unauthorized person to access the computer of the absent participant.

Current approaches to improve and secure authentication may use multi-factor-based mechanisms, which in some cases include biometric data. However, there are several limitations to these approaches when it relates to authentication in an audio-video conference. Conference systems are still allowing connections by unmanaged dial-in devices including phones or computers. This makes it harder to use biometric data, and authentication is often just single factor such as, for example, a pin/password. Conference systems usually do not perform reauthentication after a period, allowing for unauthorized access to occur after the initial authentication, through the same connection. Systems that use biometrics, such as voice or facial recognition, require a lot of training data to be able to perform authentication with a confidence level sufficient to prevent successful authentication by a deepfake impersonator. Also, current authentication systems using biometric data have static recognition in which the AI model's performance is based on the initial data collected when enrolling the biometric details.

The present disclosure provides technical solutions and benefits by introducing a novel system to validate the identify of a participant and automatically disconnect participants that do not meet the minimum required confidence thresholds. This is a continuous process to assess user authenticity, thereby minimizing security risks and preventing cybersecurity breaches/attacks. The system can utilize both active authentication and passive authentication. Active authentication can include any type of authentication that requires an explicit human activity such as entering a pin or a password, push authentication using a secondary device (e.g., mobile device), etc. Passive authentication can include any type of authentication that may be performed without an explicit human activity such as voice, face, iris, retina, etc., detection. In one or more embodiments, during the online meeting, biometric data of the participant can be collected to passively authenticate the user without disturbing the user. The biometric data can be in the form of video, audio, images, etc.

Deepfakes include images, audio, and videos which are edited or generated using artificial intelligence tools, and which may depict real or non-existent people. Deepfakes are a type of synthetic media using modern technology. With modern technology, deepfakes uniquely leverage the technological tools and techniques of machine learning and artificial intelligence including, for example, facial recognition algorithms and artificial neural networks such as variational autoencoders (VAEs) and generative adversarial networks (GANs). One or more embodiments can utilize deepfake detection technologies known to one of ordinary skill in the art. Also, one or more embodiments can utilize voice and speaker recognition technologies known to one of ordinary skill in the art.

One or more embodiments described herein can utilize machine learning techniques to perform tasks, such as classifying a feature of interest. More specifically, one or more embodiments described herein can incorporate and utilize rules-based decision making and artificial intelligence (AI) reasoning to accomplish the various operations described herein, namely classifying a feature of interest. The phrase “machine learning” broadly describes a function of electronic systems that learn from data. A machine learning system, engine, or module can include a trainable machine learning algorithm that can be trained, such as in an external cloud environment, to learn functional relationships between inputs and outputs, and the resulting model (sometimes referred to as a “trained neural network,” “trained model,” “a trained classifier,” and/or “trained machine learning model”) can be used for classifying a feature of interest. In one or more embodiments, machine learning functionality can be implemented using an Artificial Neural Network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional Neural Networks (CNN) are a class of deep, feed-forward ANNs that are particularly useful at tasks such as but not limited to analyzing visual imagery and natural language processing (NLP). Recurrent Neural Networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

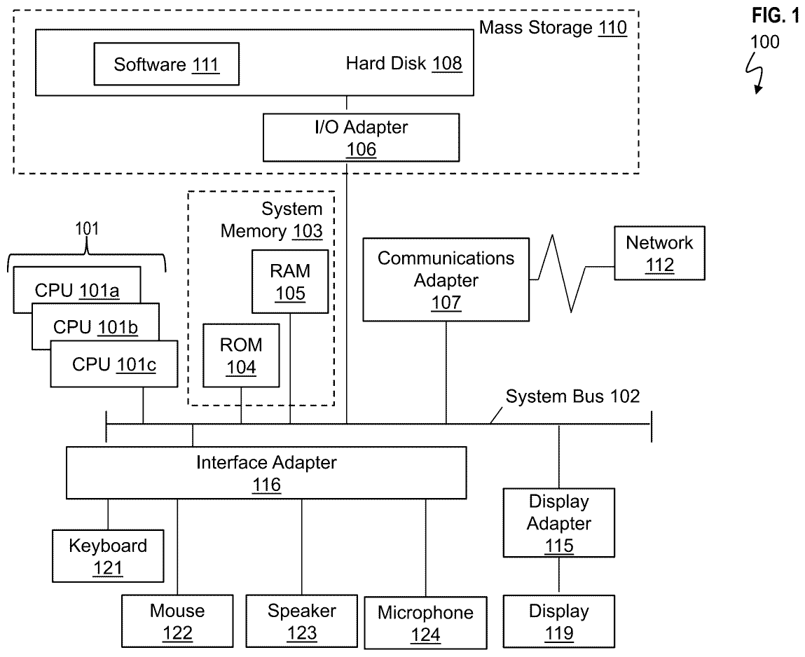

Turning now to FIG. 1, a computer system 100 is generally shown in accordance with one or more embodiments of the invention. The computer system 100 can be an electronic, computer framework comprising and/or employing any number and combination of computing devices and networks utilizing various communication technologies, as described herein. The computer system 100 can be easily scalable, extensible, and modular, with the ability to change to different services or reconfigure some features independently of others. The computer system 100 may be, for example, a server, desktop computer, laptop computer, tablet computer, or smartphone. In some examples, computer system 100 may be a cloud computing node. Computer system 100 may be described in the general context of computer system executable instructions, such as program modules, being executed by a computer system. Generally, program modules may include routines, programs, objects, components, logic, data structures, and so on that perform particular tasks or implement particular abstract data types. Computer system 100 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, the computer system 100 has one or more central processing units (CPU(s)) 101a, 101b, 101c, etc., (collectively or generically referred to as processor(s) 101). The processors 101 can be a single-core processor, multi-core processor, computing cluster, or any number of other configurations. The processors 101, also referred to as processing circuits, are coupled via a system bus 102 to a system memory 103 and various other components. The system memory 103 can include a read only memory (ROM) 104 and a random access memory (RAM) 105. The ROM 104 is coupled to the system bus 102 and may include a basic input/output system (BIOS) or its successors like Unified Extensible Firmware Interface (UEFI), which controls certain basic functions of the computer system 100. The RAM is read-write memory coupled to the system bus 102 for use by the processors 101. The system memory 103 provides temporary memory space for operations of said instructions during operation. The system memory 103 can include random access memory (RAM), read only memory, flash memory, or any other suitable memory systems.

The computer system 100 comprises an input/output (I/O) adapter 106 and a communications adapter 107 coupled to the system bus 102. The I/O adapter 106 may be a small computer system interface (SCSI) adapter that communicates with a hard disk 108 and/or any other similar component. The I/O adapter 106 and the hard disk 108 are collectively referred to herein as a mass storage 110.

Software 111 for execution on the computer system 100 may be stored in the mass storage 110. The mass storage 110 is an example of a tangible storage medium readable by the processors 101, where the software 111 is stored as instructions for execution by the processors 101 to cause the computer system 100 to operate, such as is described herein below with respect to the various Figures. Examples of computer program product and the execution of such instruction is discussed herein in more detail. The communications adapter 107 interconnects the system bus 102 with a network 112, which may be an outside network, enabling the computer system 100 to communicate with other such systems. In one embodiment, a portion of the system memory 103 and the mass storage 110 collectively store an operating system, which may be any appropriate operating system to coordinate the functions of the various components shown in FIG. 1.

Additional input/output devices are shown as connected to the system bus 102 via a display adapter 115 and an interface adapter 116. In one embodiment, the adapters 106, 107, 115, and 116 may be connected to one or more I/O buses that are connected to the system bus 102 via an intermediate bus bridge (not shown). A display 119 (e.g., a screen or a display monitor) is connected to the system bus 102 by the display adapter 115, which may include a graphics controller to improve the performance of graphics intensive applications and a video controller. A keyboard 121, a mouse 122, a speaker 123, a microphone 124, etc., can be interconnected to the system bus 102 via the interface adapter 116, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI) and the Peripheral Component Interconnect Express (PCIe). Thus, as configured in FIG. 1, the computer system 100 includes processing capability in the form of the processors 101, storage capability including the system memory 103 and the mass storage 110, input means such as the keyboard 121, the mouse 122, and the microphone 124, and output capability including the speaker 123 and the display 119.

In some embodiments, the communications adapter 107 can transmit data using any suitable interface or protocol, such as the internet small computer system interface, among others. The network 112 may be a cellular network, a radio network, a wide area network (WAN), a local area network (LAN), or the Internet, among others. An external computing device may connect to the computer system 100 through the network 112. In some examples, an external computing device may be an external webserver or a cloud computing node.

It is to be understood that the block diagram of FIG. 1 is not intended to indicate that the computer system 100 is to include all of the components shown in FIG. 1. Rather, the computer system 100 can include any appropriate fewer or additional components not illustrated in FIG. 1 (e.g., additional memory components, embedded controllers, modules, additional network interfaces, etc.). Further, the embodiments described herein with respect to computer system 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

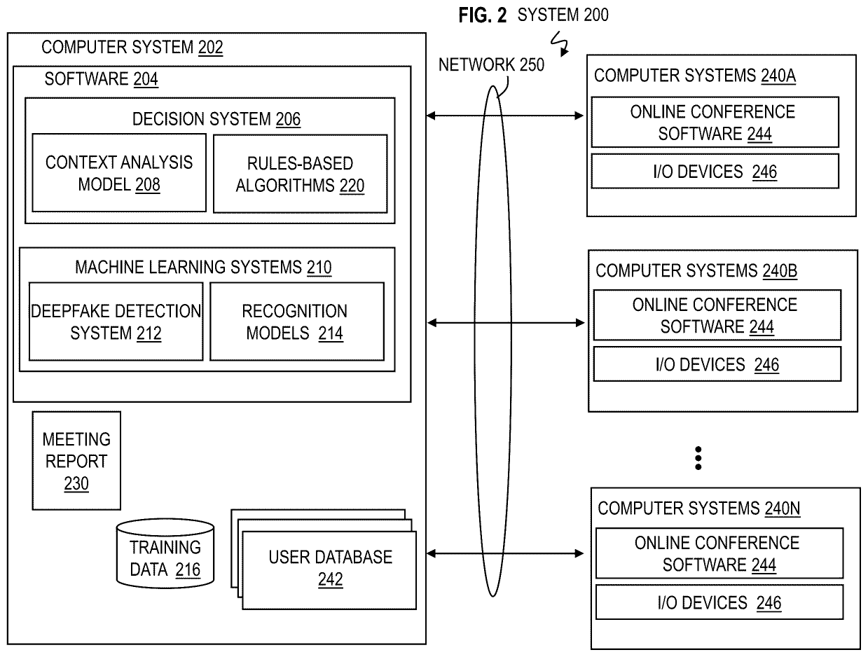

FIG. 2 depicts a block diagram of an example system 200 configured for automatically enhancing security of online conferences by continuous participant authentication and for automatically performing security actions to protect the security of the online conference according to one or more embodiments. This protects the online conference from unauthorized access, cybersecurity breaches, etc. The system 200 includes a computer system 202 configured to communicate over a network 250 with many different computer systems, such as a computer system 240A for providing the online conference to a user, a computer system 240B for providing the online conference to a user, through a computer system 240N for providing the online conference to a user. The computer systems 240A, 240B, through 240N can generally be referred to as computer systems 240 and are utilized to access the online conference which may include virtual reality, extended reality, augmented reality, video gaming, etc., offered by the computer system 202.

For explanation purposes and not limitation, some example scenarios may discuss online meetings as the online conference. It should be appreciated that one or more embodiments are not limited to examples utilizing online meetings, and the discussions apply by analogy to any real-time interactive communication environment.

In one or more embodiments, the computer systems 240 can be representative of any type of processor-based system including user devices. The user devices can include personal computers, laptops, and virtual reality equipment including headsets with displays, cameras, speakers, and/or microphones. The user devices can be a mobile device such as a cellular phone or tablet or a smart device. A smart device is an electronic device, generally connected to other devices or networks via different wireless protocols that can operate to some extent interactively. Several notable types of smart devices are smartphones, smart speakers, tablets, smartwatches, smart bands, smart glasses, and many others.

The computer systems 240 can include various software and hardware components, including online conference software 244 for online conferencing operations known by one of ordinary skill in the art. In one or more embodiments, the computer systems 240 may include client software to communicate with the computer system 202 in a server-client relationship. For example, the computer systems 240 can include software as a thin client. The software may include an application installed on the computer systems 240 and/or coupled to the computer systems 240 for access by users. In one or more embodiments, the online conference software may include and/or access a user interface to receive and display user input and output. The online conference software may include plugins, portals, webpages, remote connection software, etc., for access by the users in accordance with one or more embodiments. In one or more embodiments, the user selects an option to authorize the online conference software to execute on the computer system 202. The execution of the online conference software generates an interactive user experience that allows execution of the online conference on the computer system 240 as known by one of ordinary skill in the art.

The computer systems 240 can include one or more input/output (I/O) devices 246 including cameras, a microphone, a display, speakers, and other peripherals. The computer systems 240 can be coupled to a controller, such as a handheld controller. The computer system 202, computer systems 240, software 204, rules-based algorithms 220, etc., can include functionality and features of the computer system 100 in FIG. 1 including various hardware components and various software applications such as software 111 which can be executed as instructions on one or more processors 101 in order to perform actions according to one or more embodiments of the invention. The software 204 can include, be integrated with, and/or call various other pieces of software, algorithms, application programming interfaces (APIs), etc., to operate as discussed herein. The software 204 may be representative of numerous software applications designed to work together. In one or more embodiments, the users of the computer systems 240A-240N can register in order to utilize the online conferencing services provided by computer system 202, and each of the users has its own user profile in user database 242. The user profile may include a user account, the MAC address of the computer system, the Internet protocol (IP) address of the computer system, the location of the user, a unique user identification, etc., and/or any other identifiable information associated with the computer system and/or user. Also, the user profile includes and/or is associated with video, audio, etc., captured of the user. Each participant in the online conference has his/her own user profile in the user database 242, which is periodically updated by continuous participant authentication as discussed herein. The software 204 can perform actions and/or cause any actions to be performed for any of the participants having the user profiles in user database 242 when the computer 202 determines a potential security risk including a cybersecurity attack directed to the online conference as discussed herein.

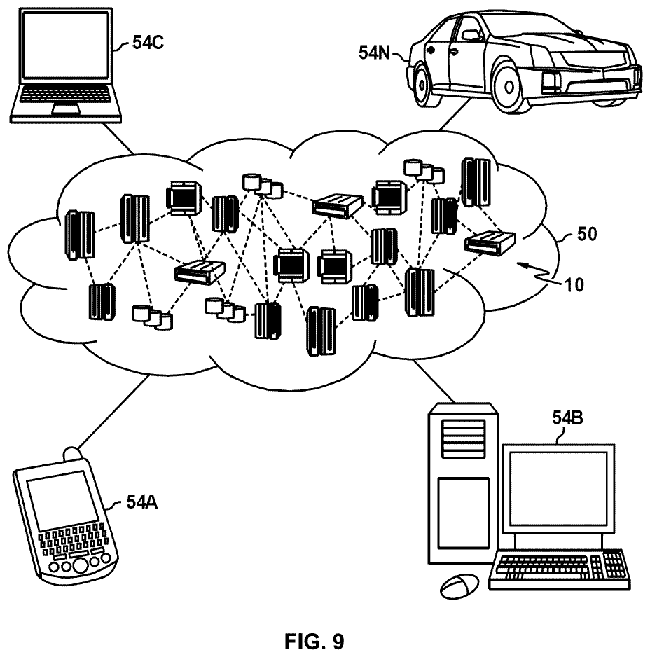

The computer system 202 may be representative of numerous computer systems and/or distributed computer systems configured to provide online conferencing services to users of the computer systems 240. The computer system 202 can be part of a cloud computing environment such as a cloud computing environment 50 depicted in FIG. 9, as discussed further herein. The network 250 can be a wired and/or wireless communication network.

The software 204 can register a new user to the online conference in various ways. In one or more embodiments, a user can be authenticated passively or actively. An authenticated user may be automatically registered with the software 204 using a recognition system of recognition machine learning models 214 once sufficient data such as audio and video data is collected about the user from the computer system 240. The user is not required to take any specific actions other than joining one or more online conferences from which the user data is captured for user recognition. The collected user data can be associated with the user and/or computer system 240 of the user, for example, in a user profile for the user in the user database 242. As noted herein, the user profile may include a user account, the MAC address of the computer system, the IP address of the computer system, the location of the user, a unique user identification for the user, etc., and/or any other identifiable information associated with the computer system and/or user. Also, the user profile includes and/or is associated with video, audio, images, etc., captured of the user. User agreement for such data capture may be given by the user at the beginning, during, and/or after the online conference and/or the user agreement can be given as part of signing up for the conference tool, for example, downloading or initiating the online conference software 244 on computer system 240. In one or more embodiments, a new participant can be asked to provide a given amount of training data, for example, as audio, video, and images by using a microphone and cameras coupled to the computer system 240, as part of the first-time signing on process into the online conference software 244. This captured data can be utilized for recognition of the user.

The software 204 can monitor the online conference for continuous authentication for users that have been registered, and the user recognition is based on user data that is presently being collected. In one or more embodiments, during an active online conference, the software 204 is configured to authenticate the participants periodically, based on the user data that is being collected (e.g., audio, video, etc.), for the users that have already been registered. If currently captured user data for a user does not match the previously stored user data, for example, stored in the user profile of the user database, a security action is executed to disconnect the computer system 240 of the user from the online conference. The decision to disconnect the user from the online conference can be based on a recognition score R for the user. The recognition score is influenced by the meeting context on the online conference.

The software 204 can generate a security conference report 230 for the online conference. In one or more embodiments, at the end of the online conference, the software 204 generates the security conference report 230 including the context analysis, the combined probability of recognizing all participants, individual recognition scores for participants, and deepfake detection scores for participants.

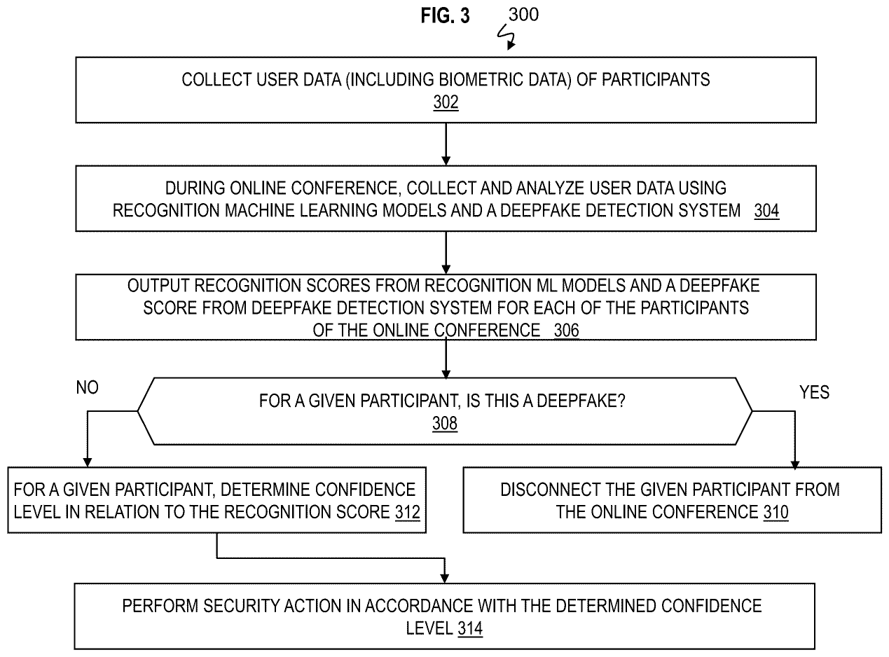

FIG. 3 is a flowchart of a computer-implemented method 300 for automatically enhancing security of online conferences by continuous participant authentication and for automatically performing security actions to protect the security of the online conference according to one or more embodiments. This protects the online conference from unauthorized access. The computer-implemented method 300 is executed by the computer system 202. Reference can be made to any figures discussed herein.

At block 302 of the computer-implemented method 300, the software 204 of computer system 202 is configured to collect user data of participants of the online conference. The user data may be collected during registration for the online conference, during the online conference itself, during one or more previous online conferences that occurred prior to the current online conference, etc. The user data includes biometric data, and biometric data can be various types of data including audio data, video data, images, eye/iris data, fingerprint data, etc., for each participant. The user data for respective participants can be stored in and/or associated with respective user profiles in the user database 242. In one or more embodiments, the software 204 can include, employ, and/or call machine learning systems 210 having machine learning models to process the user data. For instance, the software 204 can input the user data to recognition machine learning models 214 of the machine learning systems 210 to output a probability score P for each participant, and the probability score P for a given participant is used to obtain a recognition score R for that participant. Initially, the recognition score R may be the value of the probability score P for a given participant. The recognition score R is calculated to decay over time starting from the initial value of the probability score P such that the recognition score R reduces in value based on the probability score P, a reauthentication interval T, and an elapsed time t since last reauthentication. The recognition machine learning models 214 include a machine learning model for each data type such as, for example, a different machine learning model trained for audio data, video data, images, eye/iris data, fingerprint data, etc., in order to output a probability score for the participant that is utilized to determine the recognition score R.

Also, the software 204 can input the user data to a deepfake detection system 212 of the machine learning systems 210 to obtain a deepfake score for each participant. A suitable deepfake detection suitable can be utilized. Examples of deepfake detection systems may include convolutional neural networks (CNNs), recurrent neural networks (RNNs) including long short-term memory (LSTM) networks, vision transformers (ViTs), ensemble methods, etc.

At blocks 304 and 306, the software 204 of computer system 202 is configured to, during the online conference, collect and analyze user data using the recognition machine learning models 214 and the deepfake detection systems 212 and output recognition scores and deepfake scores for each of the participants of the online conference. The computer system 202 is configured to monitor the online conference and store the user data. The recognition machine learning models 214 and the deepfake detection systems 212 can analyze the collected user data dynamically, for example, in real-time or near real-time. In one or more embodiments, the computer system 202 can periodically extract the user data by collecting the user data at predetermined intervals during the online conference. The predetermined intervals may be at certain stages of the online conference, every X number of seconds, minutes, etc., for a duration of predefined length of time, etc. In some embodiments, the predetermined intervals can be modified according to a user setting. In one or more embodiments, the computer system 202 can continuously extract the user data during the online conference.

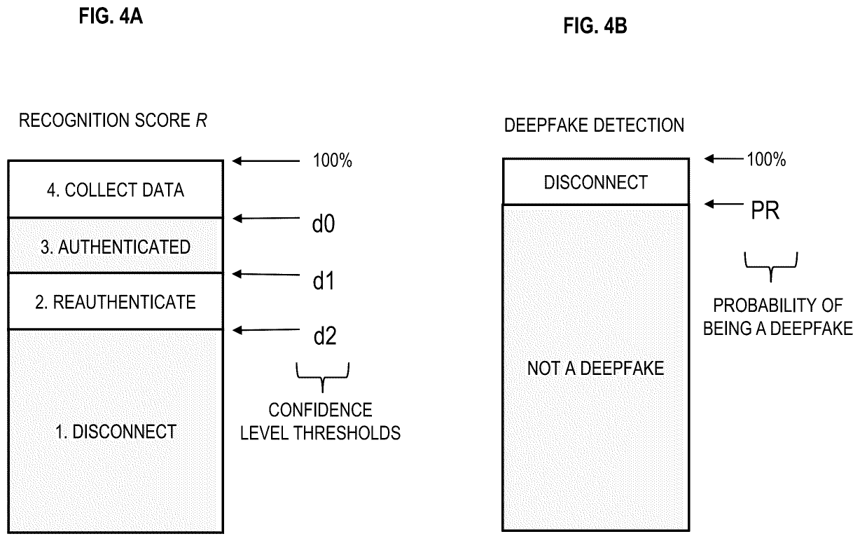

At block 308, the software 204 of computer system 202 is configured to, for a given participant, check if the user data is a deepfake. In one or more embodiments, the software 204 can include, employ, and/or call a decision system 206. The decision system 206 may include rules-based algorithms 220 structured with logic for outputting decisions and a context analysis model 208 as discussed herein. The decision system 206 receives the deepfake score for the given participant and determines whether the deepfake score reaches a deepfake threshold or probability of being a deepfake, as discussed further in FIG. 4B. A higher value for the deepfake score indicates a higher likelihood of the user data being a deepfake for the given participant. A lower value for the deepfake score indicates a lower likelihood of the user data being a deepfake for the given participant.

At block 310, when (YES) the deepfake score meets or exceeds the deepfake threshold or probability for being a deepfake of the given participant, the software 204 of computer system 202 is configured to perform one or more security actions. In one or more embodiments, the software 204 can disconnect the given participant from the online conference. The software 204 may require the given participant of the computer system 240 to login again for the online conference. The software 204 may block the computer system 240 of the given participant from logging into the online conference. The software 204 may require the given participant login again using two-factor authentication, a pin/password, biometric data, etc. In one or more embodiments, the software 204 may temporarily lock or pause the online conference and inform the meeting host that the given participant was represented by a deepfake. The software 204 can provide the meeting host on a computer system with one or more options to cancel the online meeting, resend online meeting information to the participants to create a new online meeting, continue the online meeting without the given participant, (directly) contact the given participant identified as the deepfake to confirm his/her identity, present a question to the given participant to confirm his/her identity, etc.

At block 312, when (NO) the deepfake score does not meet or exceed the deepfake threshold or probability for being a deepfake of the given participant, the software 204 of computer system 202 is configured to, for the given participant, determine an authentication/confidence interval in relation to the recognition score. As noted herein, the recognition machine learning models 214 include a machine learning model for each different data type such as, for example, a different machine learning model trained for audio data, video data, images, eye/iris data, fingerprint data, etc., in order to output a probability score for each data type. In one or more embodiments, only one or more than one type of user data is available, and the user data is input to the appropriate machine learning model in order to output a probability score for the given participant based on the given user data. In one or more embodiments, an average (which could be weighted in favor of one data type over another data type) can be taken to obtain the probability score. In one or more embodiments, each probability score is compared to confidence intervals to determine where the probability score falls. For example, a machine learning model of the recognition machine learning models 214 is trained to receive input of video data and output a probability score for the given participant, in which the probability score indicates if the given participant is recognized for who he/she claims to be. A higher value for the probability score indicates a higher likelihood of the user data being indicative of properly recognizing and/or identifying the given participant. A lower value for the probability score indicates a lower likelihood of the user data being indicative of properly recognizing and/or identifying the given participant.

In one or more embodiments, the software 204 can include, employ, and/or call the decision system 206, and the decision system 206 may include rules-based algorithms structured with logic for outputting decisions as discussed herein. The decision system 206 receives the recognition score and outputs an authentication/confidence interval corresponding to the recognition score, as depicted in FIG. 4A. Based on the authentication/confidence interval determined for the recognition score, the decision system 206 can trigger one or more security actions.

Referring to FIG. 3, at block 314, the software 204 of computer system 202 is configured to perform at least one security action in accordance with the determined confidence interval. Example security actions may include locking the online conference, requiring/requesting reauthentication for the given participant when the confidence is low, authenticating the given participant when the confidence is high, collecting more training data (e.g., training data 216) for the recognition machine learning models 214 when the confidence is high. The training data 216 is utilized to further train (and/or periodically train) the recognition machine learning models 214 and the deepfake detection system 212 using training data having a high confidence level.

FIGS. 4A and 4B depict block diagrams of example details of the decision system according to one or more embodiments. FIG. 4A depicts a block diagram of recognition thresholds for the recognition score R in which the recognition thresholds delineate the authentication/confidence intervals. As such, the recognition score R is determined to fall into one of the authentication/confidence intervals. Example recognition thresholds are depicted in ascending order as thresholds d2, d1, and d0, where d2 is the lowest and d0 is the highest recognition threshold in FIG. 4A. Although four authentication/confidence intervals are shown in FIG. 4A as for illustration purposes, more or fewer confidence intervals can be utilized. The authentication/confidence levels are depicted as 1) disconnect, 2) reauthenticate, 3) authenticated, and 3) collect data (for further training).

When the recognition score R is lower than the recognition threshold d2, the decision system 206 determines that the recognition score falls into a disconnect confidence interval. For example, for R<d2, the given participant is disconnected from the online meeting and must reauthenticate to rejoin.

When the recognition score R is lower greater the recognition threshold d2 but less than recognition threshold d1, the decision system 206 determines that the recognition score falls into a reauthenticate confidence interval. For example, for d1>R>d2, the given participant is asked to reauthenticate while remaining in the online meeting and is disconnected from the meeting if such reauthentication is not completed within a preset timeframe or fails.

When the recognition score R is lower the recognition threshold do but greater than recognition threshold d1, the decision system 206 determines that the recognition score falls into an authenticated confidence interval. For example, for d0>R>d1, the given participant is deemed to be successfully authenticated. This is a good state. In this case, no action is required by the given participant because the given participant has been passively authenticated. For example, the software 204 was able to passively authenticate the given participant using biometric data captured (that is not a deepfake) during the online conference.

When the recognition score R is greater than the recognition threshold do, the decision system 206 determines that the recognition score falls into the collect user data confidence interval. For example, for R>d0 (e.g., between d0 and 100%), the given participant is deemed to be successfully authenticated and more training data is collected from the given participant during the online meeting to further improve the machine learning model. The software 204 is configured to collect more data because the decision system 206 is confident enough (e.g., R>d0) that the user data is meaningful and is correlated to the given participant, so therefore, more data is collected for training. Again, no action is required by the given participant. To improve the performance of the machine learning model, the additional training can improve the recall (also known as true positive rate), which measures the ability of the model to identify all relevant instances, and the precision, which measures the accuracy of the positive predictions made by the model. For the machine learning model, the additional training data also improves the F1 score, which is the harmonic mean of precision and recall, and the accuracy, which measures the proportion of correct predictions made by the model out of all predictions. As more user data is updated for a given participant (e.g., when for R>d0), the machine learning models of the recognition machine learning models 214 and the deepfake detection system 212 become more confident in the ability to correctly output the recognition score and deepfake score for a given user in accordance with the amount of updated user data for the user. The user data for users is collected across many different online conferences, thereby building more training data correlated to that particular user. The recognition machine learning models 214 of the recognition detection system can utilize many deep learning architectures including convolutional neural networks, recurrent neural networks, deep neural networks, Mel-frequency cepstral coefficients, etc.

Using the recognition score R, the decision system detects if the participant is no longer at his/her the desk and takes protective security actions, such as temporarily locking the online conference, blocking audio and video streams to the computer system of the given participant, etc., until the user returns. The return of the given participant to his/or her desk can be determined by passive or active authentication.

FIG. 4B depicts a block diagram of deepfake threshold for the deepfake system according to one or more embodiments. As seen in FIG. 4B, there can be a deepfake threshold denoted as a probability PR. As a separate decision that is unrelated to the recognition score, the deepfake detection system 212 can disconnect the given participant at any point during the online conference when a deepfake is detected with a probability greater than PR. The machine learning models of the deepfake detection system 212 are improved because of the collection of further user data when the recognition score R is determined to fall in the collect training data interval (e.g., for R>d0). Accordingly, the machine learning models of the deepfake detection system 212 are further trained (and/or periodically trained) on the most recent training data (e.g., training data 216) correlated to the given participant, thereby making the deepfake detection system 212 more robust against deepfakes (especially for the given participant).

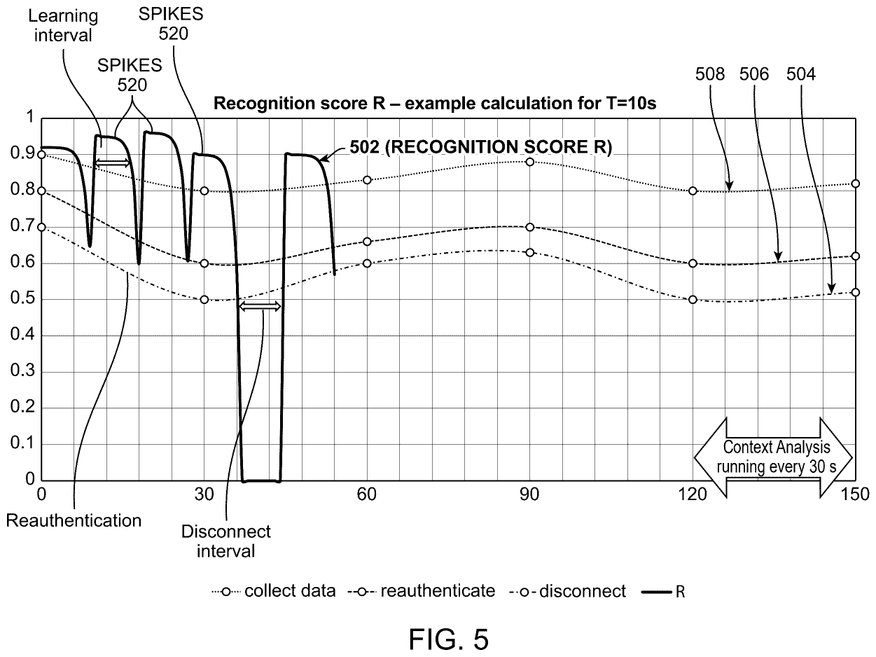

FIG. 5 depicts an example graph explaining details of the decision system according to one or more embodiments. The recognition machine learning models 214 provide a probability score Pᵢ of recognizing each participant, where i=1 to N for N participants. Based on this probability score Pᵢ, the recognition score Rᵢ is computed for a given participant in relation to the reauthentication interval T and time t since the last authentication, in an exponential relationship. As such, each participant probability Pᵢ has his/her own recognition score Rᵢ. The example exponential formula is Rᵢ=(1−e^{t-T})Pᵢ.

As an example, FIG. 5 depicts a representation of the decisions that can be taken by software 204 based on the computed recognition score R, for a particular participant. The recognition score R is based on the probability score P, and the probability score P is an output of the recognition machine learning models 214 and is therefore influenced by the quantity and quality of the data that was used to train that specific machine learning model for a user. The recognition score R is calculated to decay over time starting from the value of the probability score P.

The recognition score (represented by curve 502) decays based on an exponential formula (e.g., Rᵢ=(1−e_{t-T})Pᵢ), such that after at most T seconds the user has to reauthenticate or be disconnected from the online conference. In FIG. 5, the reauthentication interval T is 10 seconds(s), which means that the recognition machine learning models 214 determine a new recognition score R every 10 s. In the graph of FIG. 5, the position of R relative to the recognition thresholds is evaluated with a configurable frequency (e.g., every 1 second). As shown by the three series of curves 504, 506, 508, there are three recognition thresholds d2, d1, and d0 that can be met:
1) If R is above the curve 508 (collect data), data can be collected for future augmentation of the model (learning interval).
2) If R is equal to or less than the curve 506 (reauthenticate), but above the curve 504 (disconnect), then the user must be reauthenticated while remaining in the online conference. If there is enough data (audio, video, images, etc.) collected during the online conference since the last authentication, the software 204 performs a passive authentication, e.g., recalculate the recognition score R based on the new probability score P obtained from the recognition machine learning models 214. This means the machine learning models 214 periodically provide new probability score P values, which lead to new recognition score R values being calculated by the software 204. For the 3 initial spikes 520 of the recognition score R, this means that the software 204 was able to reauthenticate the user either passively (e.g., based on the user data that is collected during the online conference), or actively (e.g., by displaying a popup object on the user's desktop asking for a fingerprint, password, and/or another type of authentication).
3) Once the recognition score R on curve 502 reaches the disconnect threshold (e.g., curve 504), the user is disconnected from the online conference and has to reauthenticate with an active method to be able to rejoin the online conference. This is denoted by the period shown in the graph as the disconnect interval.

The recognition thresholds d0, d1, and d2 can change based on output from a context analysis model 208 of the decision system 206. In the example, the context analysis of the online conference is executed by the context analysis model 208, for example, every 30 seconds. The context analysis model 208 can include natural language processing, large language models (LLMs), deep learning models, etc. Example machine learning algorithms for NLP may include but are not limited to the following algorithms: support vector machines (SVM), Naïve Bayes, logistic regression, decision trees, random forests, K-nearest neighbors, gradient boosting, etc. Example deep machine learning algorithms for NLP may include convolutional neural networks (CNNs), recurrent neural networks (RNNs), long short-term memory (LSTM) networks, transformer networks, gated recurrent units (GRUs), deep belief networks (DBNs), generative adversarial networks (GANs), etc.

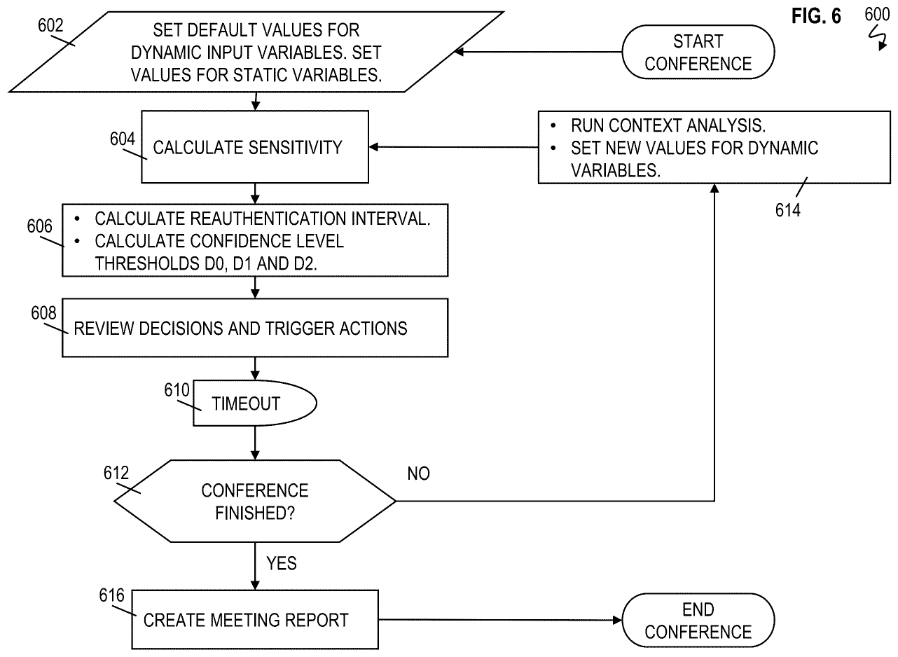

FIG. 6 depicts a flowchart illustrating further details of context analysis according to one or more embodiments. The decision system 206 is configured to analyze the current online meeting in order to adjust its parameters. The decision system 206 provides inputs to the context analysis model 208. The online conference starts for the users of computer systems 240.

At block 602, the decision system 206 is configured to input variables (features) to the context analysis model 208, which can include static variables as features and dynanic variables as features in order for the context analysis model 208 to output a sensitivity score S in a (0,1) interval. Static variables include invitees, meeting topic, meeting agenda, meeting type, etc. Dynamic variables include number of participants, actual participants, topics being discussed, tone, sentiment, etc. Embeddings are used to convert categorical or discrete data into continuous numerical vectors so that machine learning algorithms can process and learn from data that is not naturally numerical. Particularly, feature vectors are used to represent data points in a way that algorithms can process and learn from. A feature vector is an array of numerical values that represent the characteristics (features) of a data point, and each element in the vector corresponds to a specific feature of the data.

At block 604, the context analysis model 208 is configured to calculate the sensitivity score S based on the input variables. At the outset, the sensitivity score S may be set, for example, to the value 1.

The context analysis model 208 requires that the input variables be encoded as features, for example, in feature vectors. Number of participants for the online conference can remain as is because this is a numerical value. Input variables like meeting type are assigned codes from mutually exclusive categories such as, for example, All-hands=1, Direct Reports=2, Daily Project=3, etc. Variables like topics are assigned codes from overlapping categories such as, for example, Strategy=1, Finances=2, HR=4, Architectural Design=8, etc., with the variable value as an aggregate, e.g., Topics=9 for Strategy and Architectural Design.

As noted above, the context analysis model 208 can support both static and dynamic variables having categories determined based on other AI models, for example, text-to-speech, natural language processing, etc. For block 604, the context analysis model 208 calculates the sensitivity score S as a function of the m input variables xᵢ, with weights wᵢ that can be predefined or calculated as part of a linear regression model for reduced training data, or the weights wᵢ can be optimized as part of a machine learning model with an activation function g and bias w₀ with sufficient training data. The formula for sensitivity score S is as follows:

$$S = g ( {w}_{0} + {X}^{T} W ) , with X = [ \begin{matrix}{x}_{1} \\ ⋮ \\ {x}_{m}\end{matrix} ] and W = [ \begin{matrix}{w}_{1} \\ ⋮ \\ {w}_{m}\end{matrix} ]$$

As seen above, X^{T} is the transposed matrix of the set of input variables xᵢ where i ranges from 1 to m, W includes the set of weights wᵢ where i ranges from 1 to m.

At block 606, the decision system 206 is configured to calculate the reauthentication interval T and calculate the recognition level thresholds d0, d1, and d2. Based on the sensitivity score S, system parameters are calculated as follows. The reauthentication interval T can be determined using a formula where T is inversely proportional to S: for example, T=k/S, where k is a configurable system variable in seconds. As an example, k=30 s, S=0.9, and for T=k/S, then T=27 s. Recognition/confidence level thresholds di can be determined by using a formula where each recognition threshold is correlated with the sensitivity score S by a linear function, for example, di=kᵢ×S, where kᵢ, i in {0, 1, 2} are configurable system variables. Accordingly, k₁=0.95, k₂=0.9, k₃=0.8, S=0.9 then (=>) d1=0.855, d2=0.81, d3=0.72.

It is noted that the configurable parameters kᵢ are specific to the highest sensitivity score S of 1, and therefore the calculated recognition/confidence thresholds dᵢ can only be lower (which happens if S is lower than 1).

At block 608, the decision system 206 is configured to review decisions and trigger security actions based on the recognition/conference interval for the participant. For example, the decision system 206 can trigger security actions based on discussions in FIGS. 3, 4A, and 5.

At blocks 610 and 612, the decision system 206 is configured to wait a predetermined period of time and then check if the online conference is complete.

At block 614, when (NO) the online conference is not finished, the decision system 206 is configured to run context analysis and set new values for the dynamic variables.

At block 616, when (YES) the online conference is finished, the decision system 206 is configured to generate the security conference report 230 and end the conference.

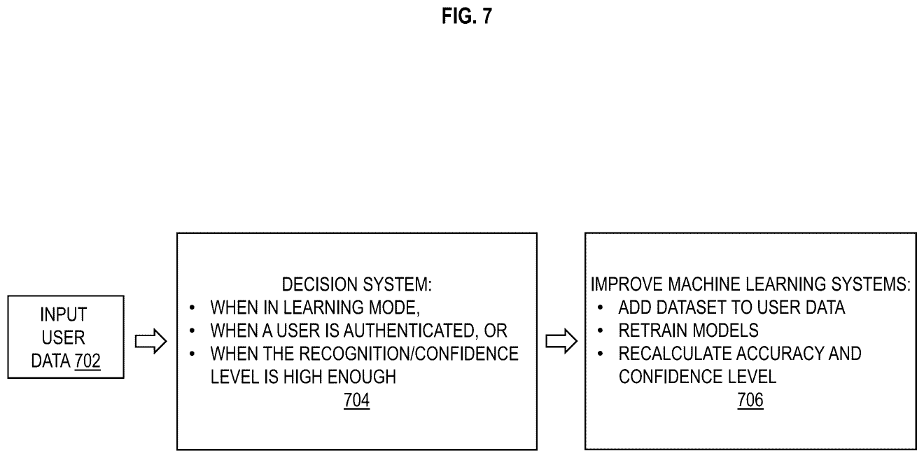

FIG. 7 depicts a block diagram of further details for continuous learning for the machine learning models according to one or more embodiments. One of the aspects of embodiments is that the software 204 is configured to continuously collect more training data while the online conference is occurring, and the software 204 self-updates the recognition machine learning models 214 and the deepfake detection system 212. In FIG. 7, the computer system 202 receives input data such as audio data, video data, images, etc., during the online conference at block 702. The decision system 206 determines that the input data can meet at least one condition to be utilized as training data 216 for the recognition machine learning models 214 and the deepfake detection system 212 at block 704. Any one of the conditions can be met to utilize the input data as training data: a) when a new user is registered or a setting for learning mode is enabled (e.g., by a system administrator); b) when a user is authenticated through a different non-expired mechanism; and/or c) when the recognition/confidence level of recognizing the user is high enough such as, for example in the authenticated interval or collect data interval. At block 706, the currently obtained user data is utilized as training data 216 to further train (e.g., as reinforcement learning) the recognition machine learning models 214 and the deepfake detection system 212 for the given participant.

With technological advances, it has become increasingly easier for cyberattackers to impersonate people in a convincing manner with deepfakes. Existing online systems that perform a one-time authentication at the beginning of a meeting are not sufficiently secure. Technical solutions and benefits provide cybersecurity protection for the online conference. The security actions prevent potential computer attacks, prevent unauthorized capture of confidential or sensitive information, etc., according to one or more embodiments. Technical solutions and benefits address impersonation attempts over audio and video calls, in which the cyberattacker is attempting to extract information in order to unauthorizedly access computer systems (e.g., hack into computer systems), or is attempting to defraud participants of the online conference by obtaining confidential/sensitive information.

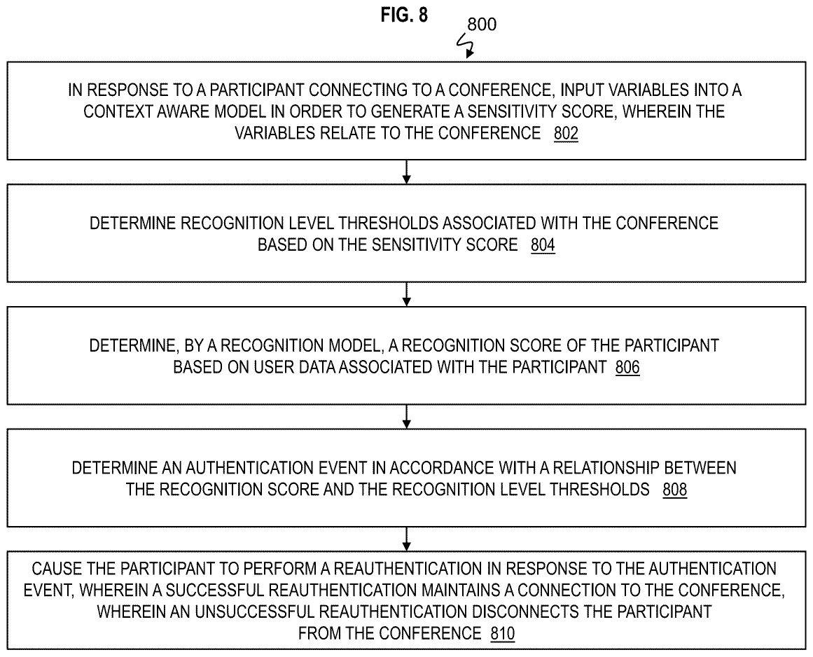

FIG. 8 is a flowchart of a computer-implemented method 800 for automatically enhancing security of online conferences by continuous participant authentication and for automatically performing security actions to protect the security of the online conference. Reference can be made to any figures discussed herein.

At block 802, the software 204 is configured to, in response to a participant connecting to a conference, input variables into a context analysis model 208 in order to generate a sensitivity score S, where the variables relate to the conference. The online conference can include one or more computer systems 240 of participants operatively connected to the computer system 202. At block 804, the software 204 is configured to determine recognition level thresholds (e.g., d0, d1, d2) associated with the conference based on the sensitivity score. At block 806, the software 204 is configured to determine, by a recognition model (e.g., recognition machine learning model 214), a recognition score R of the participant based on user data associated with the participant. At block 808, the software 204 is configured to determine an authentication event in accordance with a relationship between the recognition score and the recognition level thresholds, for example, as depicted in FIGS. 4A, 4B, and 5. At block 810, the software 204 is configured to cause the participant (e.g., using computer system 240) to perform a reauthentication in response to the authentication event, where a successful reauthentication maintains a connection to the conference, where an unsuccessful reauthentication disconnects the participant from the conference.

Further, the variables comprise static variables that are fixed for the conference and dynamic variables that vary during the conference. One or more of the dynamic variables capture a context of the conference. The software 204 is configured to determine a disconnection event in accordance with the relationship between the recognition score and the recognition level thresholds, and in response to determining the disconnection event, disconnect the participant from the conference. The participant is reconnected to the conference in response to the participant completing a login process. The login process can be the initial process to gain access to the online meeting.

The sensitivity score is updated during the conference based on changes to the variables; the recognition level thresholds are updated during the conference based on updates to the sensitivity score; and the relationship between the recognition score and the recognition level thresholds changes based on updates to the recognition level thresholds, resulting in changes to when a determination is made for the authentication event, a disconnection event, or a collect data event.

A context of the conference is determined; the user data of the participant is continuously or periodically extracted during the conference; the recognition model updates the recognition score based on the user data extracted and the context of the conference; and in response to updating the recognition score, the recognition level thresholds are updated such that the relationship between the recognition score and the recognition level thresholds changes over time during the conference, thereby affecting a determination of the authentication event.

In one or more embodiments, the context analysis model 208 and the machine learning systems 210 can include various engines/classifiers and/or can be implemented on a neural network. The features of the engines/classifiers can be implemented by configuring and arranging the computer system 202 to execute machine learning algorithms. In general, machine learning algorithms, in effect, extract features from received data (e.g., the complete message formed of segmented messages) in order to “classify” the received data. Examples of suitable classifiers include but are not limited to neural networks, support vector machines (SVMs), logistic regression, decision trees, hidden Markov Models (HMMs), etc. The end result of the classifier's operations, i.e., the “classification,” is to predict a class (or label) for the data. The machine learning algorithms apply machine learning techniques to the received data in order to, over time, create/train/update a unique “model.” The learning or training performed by the engines/classifiers can be supervised, unsupervised, or a hybrid that includes aspects of supervised and unsupervised learning. Supervised learning is when training data is already available and classified/labeled. Unsupervised learning is when training data is not classified/labeled so must be developed through iterations of the classifier. Unsupervised learning can utilize additional learning/training methods including, for example, clustering, anomaly detection, neural networks, deep learning, and the like.

In one or more embodiments, the engines/classifiers are implemented as neural networks (or artificial neural networks), which use a connection (synapse) between a pre-neuron and a post-neuron, thus representing the connection weight. Neuromorphic systems are interconnected elements that act as simulated “neurons” and exchange “messages” between each other. Similar to the so-called “plasticity” of synaptic neurotransmitter connections that carry messages between biological neurons, the connections in neuromorphic systems such as neural networks carry electronic messages between simulated neurons, which are provided with numeric weights that correspond to the strength or weakness of a given connection. The weights can be adjusted and tuned based on experience, making neuromorphic systems adaptive to inputs and capable of learning. After being weighted and transformed by a function (i.e., transfer function) determined by the network's designer, the activations of these input neurons are then passed to other downstream neurons, which are often referred to as “hidden” neurons. This process is repeated until an output neuron is activated. Thus, the activated output neuron determines (or “learns”) and provides an output or inference regarding the input.

Training datasets (e.g., training data 216) can be utilized to train the machine learning models. The training datasets can include historical data of user data for participants of past online conferences and current user data of the current online conference for the participants. Labels can be applied to respective user data to train the machine learning models, as part of supervised learning. For the preprocessing, the raw training datasets may be collected and sorted manually. The sorted dataset may be labeled (e.g., using the Amazon Web Services® (AWS®) labeling tool such as Amazon SageMaker® Ground Truth). The training dataset may be divided into training, testing, and validation datasets. Training and validation datasets are used for training and evaluation, while the testing dataset is used after training to test the machine learning model on an unseen dataset. The training dataset may be processed through different data augmentation techniques. Training takes the labeled datasets, base networks, loss functions, and hyperparameters, and once these are all created and compiled, the training of the neural network occurs to eventually result in the trained machine learning model (e.g., trained machine learning algorithms). Once the model is trained, the model (including the adjusted weights) is saved to a file for deployment and/or further testing on the test dataset.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 9, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described herein above, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 9 are intended to be illustrative only and that computing nodes 10 and cloud computing environment 50 can communicate with any type of computerized device over any type of network and/or network addressable connection (e.g., using a web browser).

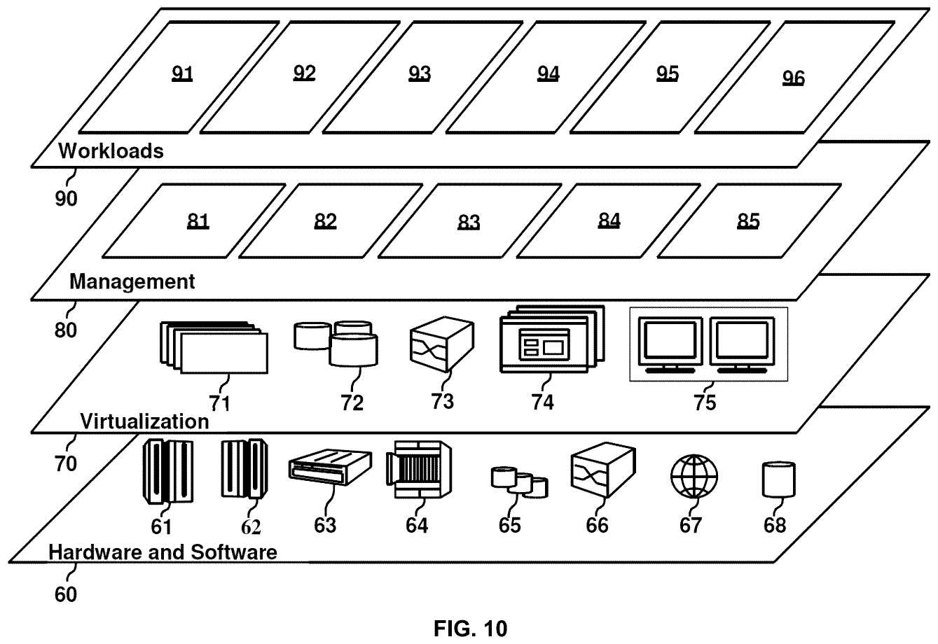

Referring now to FIG. 10, a set of functional abstraction layers provided by cloud computing environment 50 (depicted in FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and workloads and functions 96.

Various embodiments of the present invention are described herein with reference to the related drawings. Alternative embodiments can be devised without departing from the scope of this invention. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted, or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
in response to a participant connecting to a conference, inputting variables into a context analysis model in order to generate a sensitivity score, wherein the variables relate to the conference;
determining recognition level thresholds associated with the conference based on the sensitivity score;
determining, by a recognition model, a recognition score of the participant based on user data associated with the participant;
determining an authentication event in accordance with a relationship between the recognition score and the recognition level thresholds; and
causing the participant to perform a reauthentication in response to the authentication event, wherein a successful reauthentication maintains a connection to the conference, wherein an unsuccessful reauthentication disconnects the participant from the conference.

2. The computer-implemented method of claim 1, wherein the variables comprise static variables that are fixed for the conference and dynamic variables that vary during the conference.

3. The computer-implemented method of claim 2, wherein one or more of the dynamic variables capture a context of the conference.

4. The computer-implemented method of claim 1, further comprising:
determining a disconnection event in accordance with the relationship between the recognition score and the recognition level thresholds; and
in response to determining the disconnection event, disconnecting the participant from the conference.

5. The computer-implemented method of claim 4, wherein the participant is reconnected to the conference in response to the participant completing a login process.

6. The computer-implemented method of claim 1, wherein:
the sensitivity score is updated during the conference based on changes to the variables;
the recognition level thresholds are updated during the conference based on updates to the sensitivity score; and
the relationship between the recognition score and the recognition level thresholds changes based on updates to the recognition level thresholds, resulting in changes to when a determination is made for the authentication event, a disconnection event, or a collect data event.

7. The computer-implemented method of claim 1, wherein:
a context of the conference is determined;
the user data of the participant is extracted during the conference;
the recognition model updates the recognition score based on the user data extracted and the context of the conference; and
in response to updating the recognition score, the recognition level thresholds are updated such that the relationship between the recognition score and the recognition level thresholds changes over time during the conference, thereby affecting a determination of the authentication event.

8. A system comprising:
one or more memories having computer readable instructions; and
one or more processors for executing the computer readable instructions, the computer readable instructions controlling the one or more processors to perform operations comprising:
in response to a participant connecting to a conference, inputting variables into a context analysis model in order to generate a sensitivity score, wherein the variables relate to the conference;
determining recognition level thresholds associated with the conference based on the sensitivity score;
determining, by a recognition model, a recognition score of the participant based on user data associated with the participant;
determining an authentication event in accordance with a relationship between the recognition score and the recognition level thresholds; and
causing the participant to perform a reauthentication in response to the authentication event, wherein a successful reauthentication maintains a connection to the conference, wherein an unsuccessful reauthentication disconnects the participant from the conference.

9. The system of claim 8, wherein the variables comprise static variables that are fixed for the conference and dynamic variables that vary during the conference.

10. The system of claim 9, wherein one or more of the dynamic variables capture a context of the conference.

11. The system of claim 8, wherein the operations further comprise:
determining a disconnection event in accordance with the relationship between the recognition score and the recognition level thresholds; and
in response to determining the disconnection event, disconnecting the participant from the conference.

12. The system of claim 11, wherein the participant is reconnected to the conference in response to the participant completing a login process.

13. The system of claim 8, wherein:
the sensitivity score is updated during the conference based on changes to the variables;
the recognition level thresholds are updated during the conference based on updates to the sensitivity score; and
the relationship between the recognition score and the recognition level thresholds changes based on updates to the recognition level thresholds, resulting in changes to when a determination is made for the authentication event, a disconnection event, or a collect data event.

14. The system of claim 8, wherein:
a context of the conference is determined;
the user data of the participant is extracted during the conference;
the recognition model updates the recognition score based on the user data extracted and the context of the conference; and
in response to updating the recognition score, the recognition level thresholds are updated such that the relationship between the recognition score and the recognition level thresholds changes over time during the conference, thereby affecting a determination of the authentication event.

15. A computer program product comprising a computer readable storage medium having program instructions embodied therewith, the program instructions executable by one or more processors to cause the one or more processors to perform operations comprising:
in response to a participant connecting to a conference, inputting variables into a context analysis model in order to generate a sensitivity score, wherein the variables relate to the conference;
determining recognition level thresholds associated with the conference based on the sensitivity score;
determining, by a recognition model, a recognition score of the participant based on user data associated with the participant;
determining an authentication event in accordance with a relationship between the recognition score and the recognition level thresholds; and
causing the participant to perform a reauthentication in response to the authentication event, wherein a successful reauthentication maintains a connection to the conference, wherein an unsuccessful reauthentication disconnects the participant from the conference.

16. The computer program product of claim 15, wherein the variables comprise static variables that are fixed for the conference and dynamic variables that vary during the conference.

17. The computer program product of claim 16, wherein one or more of the dynamic variables capture a context of the conference.

18. The computer program product of claim 15, wherein the operations further comprise:
determining a disconnection event in accordance with the relationship between the recognition score and the recognition level thresholds; and
in response to determining the disconnection event, disconnecting the participant from the conference.

19. The computer program product of claim 18, wherein the participant is reconnected to the conference in response to the participant completing a login process.

20. The computer program product of claim 15, wherein:
the sensitivity score is updated during the conference based on changes to the variables;
the recognition level thresholds are updated during the conference based on updates to the sensitivity score; and
the relationship between the recognition score and the recognition level thresholds changes based on updates to the recognition level thresholds, resulting in changes to when a determination is made for the authentication event, a disconnection event, or a collect data event.
